(19) United States
(12) Patent Application Publication
(10) Pub. No.: US 2025/0339799 A1
(43) Pub. Date: Nov. 6, 2025

(54) FILTER MEDIA, TRIBOELECTRICALLY CHARGED FIBERS THEREOF, AND METHODS FOR THE SAME

(71) Applicant: DelStar Technologies, Inc., Alpharetta, GA (US)

(72) Inventors: Yasar Kiyak, Middletown, DE (US); Andrew G. Platt, Middletown, DE (US)

(21) Appl. No.: 19/196,643

(22) Filed: May 1, 2025

Related U.S. Application Data
(60) Provisional application No. 63/641,491, filed on May 2, 2024.

(51) Int. Cl. B01D 39/16; B01D 46/00; D04H 3/007; D04H 3/011; D04H 3/016; D04H 3/10; D04H 3/105; D04H 3/11; D04H 3/14; D04H 3/16

(52) U.S. Cl. CPC B01D 39/1661; B01D 46/0032; D04H 3/007; D04H 3/011; D04H 3/016; D04H 3/10; D04H 3/105; D04H 3/11; D04H 3/14; D04H 3/16; B01D 2239/0216; B01D 2239/0435; B01D 2239/0618; B01D 2239/0622; B01D 2239/0627; B01D 2239/0659; B01D 2239/0663; B01D 2239/0672; B01D 2239/10; B01D 2239/1233; B01D 2239/1291; D10B 2321/022; D10B 2331/041; D10B 2505/04

(57) ABSTRACT

Filter media, filters and methods for preparing filter media are provided herein. The filter media may include a nonwoven sheet having continuous fibers prepared from first and second dissimilar polymers that are triboelectrically charged. The nonwoven sheet may be prepared by needling and/or hydroentangling the continuous fibers. Needling and/or hydroentangling the continuous fibers triboelectrically charges at least a portion of the continuous fibers of the nonwoven sheet. In addition, needling and/or hydroentangling the fibers increases the loftiness of the nonwoven sheet, thereby reducing its resistance to airflow and increasing its dust holding capacity.

### CROSS-REFERENCE TO RELATED APPLICATIONS

This application claims the benefit of U.S. Provisional Application No. 63/641,491, filed May 2, 2024, the complete disclosure of which is incorporated herein by reference for all purposes.

### TECHNICAL FIELD

This description generally relates to filter media and filters for gas filtration, and more particularly to filter media comprising continuous fibers triboelectrically charged with each other.

### BACKGROUND

Conventional gas filters, such as depth filters, often utilize or are fabricated from nonwoven sheets of fibers capable of or configured to separate or remove contaminants or particulates (e.g., dust, pollen, mold, bacteria, etc.) from the air passing therethrough. The gas filters generally employ one or more types of fibers in the form of the nonwoven sheets to form tortuous paths between the fibers to retain or capture the contaminants. While conventional gas filters have a relatively high efficacy in separating contaminants, the physical filtration of the contaminants is often limited by the tortuous paths formed in the nonwoven sheets. In view of the foregoing, the nonwoven sheets of conventional gas filters often utilize electrostatically charged fibers to provide the ability to further separate contaminants and particulates via electrostatic interactions. Electrostatic or “electret” gas filters provide increased filtering efficiency without increasing the amount of force required to push the air through the filter media.

Processes for electrostatically charging the fibers for the electret gas filters include corona charging, hydro-charging, electrostatic fiber spinning, triboelectric charging, or the like. Conventional processes for preparing triboelectrically charged fibers, in particular, often includes mixing or blending two or more dissimilar discontinuous fibers (e.g., staple fibers), carding the mixture of discontinuous fibers, and needling the discontinuous fibers to bond or consolidate the discontinuous fibers with one another. The combination of carding and needling the discontinuous fibers may often provide the friction necessary to triboelectrically charge the discontinuous fibers. While conventional processes for preparing the triboelectrically charged fibers provide overall good results, recent trends have attempted to further simplify or improve the process by reducing costs and/or steps thereof.

### BRIEF SUMMARY

The following is intended merely to introduce a simplified summary of some aspects of one or more implementations of the subject matter discussed herein. Further areas of applicability of the subject matter will become apparent from the detailed description provided hereinafter. This summary is not an extensive overview, nor is it intended to identify key or critical elements of the present teachings, nor to delineate the scope of the subject matter. Rather, its purpose is merely to present one or more concepts in simplified form as a prelude to the detailed description below.

Filter media, filters and methods for preparing filter media are provided herein. The filter media may include a nonwoven sheet having continuous fibers prepared from first and second dissimilar polymers that are triboelectrically charged. The nonwoven sheet may be prepared by needling and/or hydroentangling the continuous fibers. Needling and/or hydroentangling the continuous fibers may triboelectrically charge at least a portion of the continuous fibers of the nonwoven sheet. In addition, needling and/or hydroentangling the fibers increases the loftiness of the nonwoven sheet, thereby reducing its resistance to airflow and increasing its dust holding capacity.

In accordance with one aspect, a filter media comprises continuous fibers comprising a first polymer and a second polymer. The first polymer is different than the second polymer and at least a portion of the continuous fibers are triboelectrically charged.

Providing a triboelectrically charged filter media with continuous fibers (rather than discontinuous or staple fibers) reduces the number of production steps, thereby decreasing the overall cost of the filter media. In addition, Applicant has surprisingly discovered that the filter media provided herein have improved performance over conventional filter media. In particular, the filter media provided herein demonstrate a reduction in particle penetration and therefore an increase in filter efficiency.

In some embodiments, the continuous fibers comprise spunbond fibers, melt-blown fibers, or a combination thereof. In an exemplary embodiment, the continuous fibers consist of spunbond fibers and melt-blown fibers. In one embodiment, the continuous fibers consist of only spunbond fibers.

In some embodiments, the filter media comprises a nonwoven sheet of continuous fibers needled or hydroentangled with each other. Needling and/or hydroentangling the fibers increases the loftiness of the nonwoven sheet, thereby reducing its resistance to airflow and increasing its dust holding capacity. Needlepunching not only intermingles the fibers, it also creates triboelectrification due to frictional effects.

In some embodiments, the nonwoven sheet has a thickness of about 50 mils to about 150 mils, or about 80 mils to about 120 mils, or about 100 mils to about 110 mils, or about 105 mils.

In some embodiments, the nonwoven sheet has a basis weight of about 80 gsm to about 140 gsm, or about 110 gsm to about 125 gsm, or about 118 gsm. Needling the nonwoven sheet increases its thickness while substantially maintaining its basis weight, thereby increasing the loftiness of the filter media.

In some embodiments, the continuous fibers have an average diameter of about 1 micron to about 100 microns, or about 1 micron to about 30 microns, or about 1 micron to about 10 microns, or less than 10 microns. The relatively low fiber diameters increases the charge density of the nonwoven sheet.

The first polymer may include, but is not limited to, polypropylene (PP), polyacrylic acid (PAA), ester derivatives of polyacrylic acid, poly(methyl methacrylate) (PMMA), acrylonitrile butadiene styrene (ABS), nylon, polylactic acid (PLA), polyether ether ketone (PEEK), polyetherimide (PEI), polyethylene (PE), polypropylene, polystyrene (PS), polyvinyl chloride (PVC), copolymers thereof, derivatives thereof, and combinations thereof. In an exemplary embodiment, the first polymer comprises PP. In certain embodiments, the PP has a melt flow index (MFI) of about 20 to about 35, or about 20 to about 25.

The second polymer may include, but is not limited to, polyacrylic acid (PAA), ester derivatives of polyacrylic acid, poly(methyl methacrylate) (PMMA), acrylonitrile butadiene styrene (ABS), nylon, polylactic acid (PLA), polyether ether ketone (PEEK), polyetherimide (PEI), polyethylene (PE), polypropylene, polystyrene (PS), polyvinyl chloride (PVC), copolymers thereof, derivatives thereof, and combinations thereof. In an exemplary embodiment, the second polymer comprises PLA.

In some embodiments, the continuous fibers may include monocomponent fibers prepared from the first polymer, and monocomponent fibers prepared from the second polymer.

In some embodiments, the nonwoven sheet may include a first layer including the monocomponent fibers prepared from the first polymer, and a second layer comprising the monocomponent fibers prepared from the second polymer.

In some embodiments, the nonwoven sheet may include a first layer including a combination of the monocomponent fibers prepared from the first polymer and the monocomponent fibers prepared from the second polymer.

In some embodiments, the continuous fibers may include multicomponent fibers prepared from the first polymer and the second polymer.

In some embodiments, respective fibers of the multicomponent fibers may include one or more of the following configurations: side-by-side, core-shell, islands in the sea, solid segmented pie, hollow segmented pie, ribbon, segmented ribbon, tipped multilobal, segmented cross (e.g., trilobal segmented cross), or a combination thereof.

In some embodiments, respective fibers of the multicomponent fibers may include a configuration selected from the group consisting of: side-by-side, core-shell, islands in the sea, solid segmented pie, hollow segmented pie, ribbon, segmented ribbon, tipped multilobal, segmented cross, and combinations thereof.

In some embodiments, the first polymer may be triboelectrically charged by the second polymer.

In some embodiments, the continuous fibers of the nonwoven sheet may not be thermally bonded with one another.

In some embodiments, the continuous fibers of the nonwoven sheet may not be crimped, carded, or a combination thereof.

In some embodiments, the continuous fibers of the nonwoven sheet may be bonded to one another via ultrasonic bonding.

In some embodiments, the continuous fibers of the nonwoven sheet are bonded to one another via point calendar bonding.

In some embodiments, the continuous fibers on a first side of the nonwoven sheet may have an average diameter relatively greater than the continuous fibers on a second side of the nonwoven sheet. The average diameter of the continuous fibers may decrease according to a gradient from the first side towards the second side of the nonwoven sheet.

In some embodiments, the continuous fibers may be free or substantially free of a spin finish.

In accordance with another aspect, a filter media comprises a nonwoven sheet of needled continuous fibers. At least a portion of the continuous fibers are triboelectrically charged.

In some embodiments, the nonwoven sheet comprises first and second dissimilar polymers.

In some embodiments, the nonwoven sheet has a particle penetration of less than about 50% at 32 liters/minute (lpm), or less than about 35% at 32 liters/minute (lpm). The nonwoven sheet may have particle penetration of less than about 75% at 85 liters/minute (lpm), or less than about 50% at 85 liters/minute (lpm), or less than about 45% at 85 liters/minute (lpm).

In some embodiments, the nonwoven sheet has a resistivity of about 0.3 to about 0.6 at 32 liters/minute (lpm) and about 0.9 to about 1.1 at 85 liters/minute (lpm).

In accordance with still another aspect, a method for preparing a filter media comprises producing continuous fibers from a first polymer and a second polymer, wherein the first polymer is different than the second polymer and needling the continuous fibers to prepare a nonwoven sheet of the continuous fibers, wherein the continuous fibers are triboelectrically charged via needling.

In some embodiments, the method further comprises bonding the continuous fibers with one another to prepare the nonwoven sheet. The fibers may be bonded via ultrasonic bonding and/or point calendar bonding.

In some embodiments, the continuous fibers may include monocomponent fibers prepared from a first polymer and monocomponent fibers prepared from a second polymer.

In some embodiments, spunbonding the continuous fibers may include: spunbonding a first layer of the nonwoven sheet, and spunbonding a second layer of the nonwoven sheet. The first layer may include the monocomponent fibers prepared from the first polymer. The second layer may include the monocomponent fibers prepared from the second polymer.

In some embodiments, spunbonding the continuous fibers may include spunbonding the first layer of the nonwoven sheet, and spunbonding a second layer of the nonwoven sheet. The first layer may include the monocomponent fibers prepared from the first polymer and monocomponent fibers prepared from the second polymer. The second layer may include the monocomponent fibers prepared from the first polymer and monocomponent fibers prepared from a third polymer.

In some embodiments, the continuous fibers may include multicomponent fibers prepared from the first polymer and the second polymer.

In some embodiments, the multicomponent fibers may include one or more of the following configurations: side-by-side, core-shell, islands in the sea, solid segmented pie, hollow segmented pie, ribbon, segmented ribbon, tipped multilobal, segmented cross, or a combination thereof.

In some embodiments, the first polymer may be triboelectrically charged by the second polymer.

In some embodiments, the continuous fibers may not be thermally bonded, crimped, or carded.

In some embodiments, the method may further include ultrasonically bonding at least a portion of the continuous fibers with one another.

In some embodiments, the method may further include melt blowing the continuous fibers from the first polymer, the second polymer, or a combination thereof.

Further areas of applicability of the subject matter will become apparent from the detailed description provided hereinafter. It should be understood that the detailed description and specific examples, while indicating some typical aspects of the subject matter, are intended for purposes of illustration only and are not intended to limit the scope thereof.

The recitation herein of desirable objects which may be met by various embodiments of the present description is not meant to imply or suggest that any or all of these objects may be present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the subject matter and, together with the description, serve to explain the principles thereof.

FIGS. 1A-1H illustrate schematic cross-sectional views of exemplary multicomponent fibers, according to one or more implementations.

FIGS. 2A-2E illustrate schematic cross-sectional views of exemplary nonwoven sheets and fibers thereof, according to one or more implementations.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

As used herein, “free” or “substantially free” of a material may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

Filter media, nonwoven sheet or textiles, and fibers thereof are described. The filter media, the nonwoven sheets, and the fibers thereof may be utilized in filters and/or filter devices. Illustrative filters may be or include, but are not limited to, gas filters, liquid filters, face masks, CPAP filters, vacuum bags, cabin air filters, HVAC furnace filters, gas turbine, compressor air intake filters, panel filters, residential air filters, commercial air filters, cabin air filter, engine air filter, a Minimum Efficiency Reporting Value (MERV) filter, a UV light filter, a washable filter, a medium filter, a pleated air filter, an unpleated air filter, an active carbon filter, a pocket filter, a V-bank compact filter, a filter sheet, a flat cell filter, a filter cartridge, or the like. Systems and methods for manufacturing the filter media, the nonwoven sheets, and the fibers thereof are also described. The filters that utilize the nonwoven sheets described herein may include a support layer, a scrim layer, or any other layers or materials conventionally utilized in filters.

The filter media may include one or more nonwoven sheets. Each of the nonwoven sheets may include fibers prepared from one or more polymers, one or more resins, or any combination thereof. The nonwoven sheet or the fibers thereof may be triboelectrically charged. It should be appreciated that the triboelectric effect (also known as triboelectricity, triboelectric charging, triboelectrification, or tribocharging) describes electric charge transfer between two objects slid, rubbed, or otherwise contacted with one another. It should also be appreciated that the degree of the triboelectric effect (e.g., the polarity and/or strength of the resulting charge) may be dependent, at least in part, on the respective materials and/or properties thereof, surface morphology (e.g., roughness, smoothness, etc.), temperature, strain (e.g., elastic strain), or the like.

The fibers of the nonwoven sheet may be or include electret fibers. As used herein, the term or expression “electret fibers” may refer to fibers including a dielectric material that has a quasi-permanent state of electric polarization. The respective fibers of each of the nonwoven sheets may be or include filament or continuous fibers. The continuous fibers may be spunbond fibers, melt-blown fibers, or a combination thereof. In at least one example, the continuous fibers include spunbond fibers. In another example, the continuous fibers include a combination of spunbond fibers and melt-blown fibers. The continuous fibers may be needled or subjected to a needling process to prepare the nonwoven sheet. As further described herein, needling the continuous fibers may triboelectrically charge the fibers. In at least one implementation, the filter media may be free or substantially free of staple fibers.

In an exemplary implementation, the fibers of the nonwoven sheets include continuous spunbond fibers. Conventional nonwoven sheets of spunbond fibers are generally referred to as having two-dimensional (2D) structures (e.g., after calendaring), where fibrous webs have a weight of from about 10 grams per square meter (g/m² or gsm) to about 310 gsm, about 80 gsm to about 100 gsm, or about 90 gsm, and where the nonwoven sheets have a thickness of from about 0.1 mm to about 50 mm, about 1 mm to about 10 mm, or about 2 mm to about 4 mm, or about 3 mm. The nonwoven sheets described herein, however, may have three-dimensional (3D) structures, where the fibers have a weight of from about 20 gsm to about 300 gsm, about 40 gsm to about 200 gsm, or about 60 gsm to about 150 gsm, and where the nonwoven sheets have a thickness of from about 1 mm to about 50 mm or more, about 1.5 mm to about 30 mm or more, about 2 mm to about 10 mm or more, or about 2.5 mm to about 5 mm or more. It should be appreciated that conventional 2D nonwoven sheets of spunbond fibers are not conventionally needled, much less, needled to triboelectrically charge the fibers thereof, as needling is not generally capable of or configured to interlocking continuous fibers or filaments or triboelectrically charge the fibers, and needling 3D nonwoven sheets may break the fibers, thereby preventing the fibers from being interlocked with one another.

The nonwoven sheet may have a mean flow pore size of from about 5 μm to about 200 μm. For example, the nonwoven sheet may have a mean flow pore size of from about 5 μm, about 15 μm, or about 25 μm to about 35 μm, about 50 μm, or about 75 μm. It should be appreciated that the mean flow pore size may be determined by capillary flow porometry (CPC), which is a technique utilized to evaluate the through-pore size distribution and/or permeability characteristics of a material.

The nonwoven sheet may have an air permeability, measured at about 125 Pa of from about 100 ft³/ft²/min (about 50.8 cc/cm²/sec) to about 700 ft³/ft²/min (about 355.6 cc/cm²/sec). For example, the nonwoven sheet may have an air permeability at about 125 Pa of from about 100 ft³/ft²/min, about 150 ft³/ft²/min, about 200 ft³/ft²/min, about 250 ft³/ft²/min, about 300 ft³/ft²/min, or about 350 ft³/ft²/min to about 400 ft³/ft²/min, about 450 ft³/ft²/min, about 500 ft³/ft²/min, about 550 ft³/ft²/min, about 600 ft³/ft²/min, about 650 ft³/ft²/min, or about 700 ft³/ft²/min. In another example, the nonwoven sheet may have an air permeability at about 125 Pa of from about 100 ft³/ft²/min to about 700 ft³/ft²/min, about 150 ft³/ft²/min to about 650 ft³/ft²/min, about 200 ft³/ft²/min to about 600 ft³/ft²/min, about 250 ft³/ft²/min to about 550 ft³/ft²/min, about 300 ft³/ft²/min to about 500 ft³/ft²/min, about 350 ft³/ft²/min to about 450 ft³/ft²/min, or about 400 ft³/ft²/min. In yet another example, the nonwoven sheet may have an air permeability of from about 100 ft³/ft²/min to about 300 ft³/ft²/min, about 150 ft³/ft²/min to about 250 ft³/ft²/min, or about 200 ft³/ft²/min. It should be appreciated that the air permeability may be determined or measured according to reference test ASTM-D737 of the American Society for Testing and Materials (ASTM).

In some embodiments, the nonwoven sheet has a thickness of about 50 mils to about 150 mils, or about 80 mils to about 120 mils, or about 100 mils to about 110 mils, or about 105 mils.

In some embodiments, the nonwoven sheet has a basis weight of about 80 gsm to about 140 gsm, or about 110 gsm to about 125 gsm, or about 118 gsm. Needling the nonwoven sheet increased its thickness while substantially maintaining its basis weight, thereby increasing the loftiness of the filter media.

In some embodiments, the continuous fibers have an average diameter of about 1 micron to about 100 microns, or about 1 micron to about 30 microns, or about 1 micron to about 10 microns, or less than 10 microns. The relatively low fiber diameters increases the charge density of the nonwoven sheet.

As discussed above, the continuous fibers of the nonwoven sheet may be needled or subjected to a needling process to prepare the nonwoven sheet. It should be appreciated that needling the fibers may triboelectrically charge at least a portion of the fibers of the nonwoven sheet. In at least one implementation, the fibers of the nonwoven sheet or layers thereof may be coupled with one another. The fibers may be coupled with one another via mechanical, thermal, and/or chemical means or processes. In an exemplary implementation, the fibers are not bonded to one another via a thermal process. For example, the fibers of the nonwoven sheet are not bonded to one another by applying heat to at least partially melt the fibers thereof. Illustrative heating processes include calendaring with one or more heated rollers, point bonding via calendaring, or the like. In an exemplary implementation, the fibers are bonded with one another via needling or needle-punching, ultrasonic bonding, or a combination thereof. It should be appreciated that thermally bonding the fibers may at least partially dissipate the triboelectric charge on the fibers (e.g., via needling). Accordingly, bonding the fibers via a non-thermal process, such as ultrasonic bonding, eliminates the detrimental thermal bonding process. Ultrasonic bonding may be conducted on less than or equal to 20%, less than or equal to 15%, less than or equal to 10%, less than or equal to 7%, or less of the nonwoven sheet or the fibers thereof. For example, ultrasonic bonding may only be applied to less than or equal to 20%, less than or equal to 15%, less than or equal to 10%, less than or equal to 7%, or less of the surface area of the nonwoven sheet or the fibers thereof. In at least one implementation, the fibers may be bonded with one another via point calendar bonding, thereby minimizing exposure to the thermal treatment. Other bonding processes may be or include, but are not limited to, air-through bonding, hydroentangling, or the like, or any combination thereof.

One or more variables of needling may be modified to at least partially increase or decrease the triboelectric charging of the fibers of the nonwoven sheet. For example, the depth of needling, the density of needling, the length of the needles, the speed of needling, or a combination thereof may be modified to adjust the triboelectric charge on the nonwoven sheet. The nonwoven sheet may be needled on the first side, the second side, or both sides to triboelectrically charge the fibers thereof.

In at least one implementation, the nonwoven sheet of the filter media may be prepared from a plurality of polymers, resins, or a combination thereof. For example, the respective fibers of the nonwoven sheet may be prepared from two or more polymers. Each of the polymers and/or resins may be different from one another. For example, the nonwoven sheet may be prepared from a combination of a first polymer and a second polymer, and the first polymer may be different than the second polymer. As used herein, the designation of a first, second, third, fourth, or more when referring to a “polymer” is merely to indicate that one polymer is different from any of the remaining polymers and is not intended to limit a first polymer to any particular polymer. For example, a first polymer is different from a second polymer and a third polymer. It should be appreciated, however, that the first polymer in one implementation or embodiment may also be the second polymer in another implementation. For example, the first polymer may be polyacrylic acid in one embodiment and poly(methyl methacrylate) in another embodiment. As used herein, the differences between any one of the polymers may be or include, but is not limited to, one or more of an average molecular weight, a composition, a melting point, a glass transition temperature, a tensile strength, viscoelasticity, heat conductivity, elastic modulus, the presence or absence of one or more additives, or the like, or any combination thereof.

The weight ratio of a first polymer to any one of the remaining polymers (e.g., second polymer, third polymer, etc.) may be from about 10:1 (e.g., about 10 to about 1), about 5:1, about 3:1, about 2:1, or about 1:1 to about 1:2, about 1:3, about 1:5, or about 1:10. In an exemplary implementation, the weight ratio of the first polymer to any of the remaining polymers may be from about 2:1 to about 1:2, or about 1:1.

The weight ratio of a first type of fiber or first plurality of fibers to another type of fiber or second plurality of fibers may be from about 10:1 (e.g., about 10 to about 1), about 5:1, about 3:1, about 2:1, or about 1:1 to about 1:2, about 1:3, about 1:5, or about 1:10. In an exemplary implementation, the weight ratio of the first type of fiber to any one of the remaining types of fibers may be from about 2:1 to about 1:2, or about 1:1. As used herein, the designation of a first, second, third, fourth, or more when referring to a “type of fiber” or “plurality of fiber” is merely to indicate that the first type of fiber or the first plurality of fiber is different from any of the remaining fibers (e.g., second type of fiber, third type of fiber, etc.), and is not intended to limit the first type of fiber to any specific fiber. For example, a first type of fiber may be a monocomponent fiber prepared from a first polymer, and a second type of fiber may be a monocomponent fiber prepared from a second polymer. In another example, a first type of fiber may be a monocomponent fiber prepared from a first polymer, and a second type of fiber may be a bicomponent fiber prepared from a second polymer and a third polymer. In another example, a first type of fiber may be a bicomponent fiber prepared from a first polymer and a second polymer, and a second type of fiber may be a bicomponent fiber prepared from the first and second polymers with different weight ratios or concentrations than the first type of fibers. In yet another example, a first type of fiber may be a bicomponent fiber prepared from a first polymer and a second polymer, and a second type of fiber may be a bicomponent fiber prepared from the first polymer and a third polymer. Other modifications and variations are contemplated.

The nonwoven sheet may include any type of fiber in an amount of from about 10 wt % to about 90 wt %, based on the total weight of the nonwoven sheet. For example, a first type of fiber or a second type of fiber may be present in the nonwoven sheet in an amount of from about 10 wt %, about 20 wt %, about 30 wt %, or about 40 wt % to about 50 wt %, about 60 wt %, about 70 wt %, about 80 wt %, or about 90 wt %, based on the total weight of the nonwoven sheet. In another example, the first type of fiber or the second type of fiber may be present in the nonwoven sheet in an amount of from about 10 wt % to about 90 wt %, about 20 wt % to about 80 wt %, about 30 wt % to about 70 wt %, or about 40 wt % to about 60 wt %, based on the total weight of the nonwoven sheet.

The fibers of the nonwoven sheet may be or include monocomponent fibers, multicomponent fibers, or a combination thereof. For example, the nonwoven sheet may include one or more of monocomponent fibers prepared from a first polymer, monocomponent fibers prepared from a second polymer, monocomponent fibers prepared from a third polymer, or a combination thereof. In another example, the nonwoven sheet may include monocomponent fibers prepared from a first polymer, multicomponent fibers prepared from the first polymer and a second polymer, or a combination thereof. In yet another example, the nonwoven sheet may include multicomponent fibers prepared from the first polymer and the second polymer, multicomponent fibers prepared from the first polymer and a third polymer, or a combination thereof. In yet another example, the nonwoven sheet may include multicomponent fibers prepared from a combination of the first polymer and the second polymer. In yet another example, the nonwoven sheet may include multicomponent fibers prepared from a combination of the first polymer and the second polymer and multicomponent fibers prepared from a combination of the third polymer and a fourth polymer. Other permutations and combinations with respect to monocomponent and multicomponent fibers are contemplated. In an exemplary implementation, the nonwoven sheet may include at least a combination of monocomponent fibers prepared from the first polymer and monocomponent fibers prepared from the second polymer. In another exemplary implementation, the nonwoven sheet may include at least multicomponent fibers prepared from a combination of the first polymer and the second polymer.

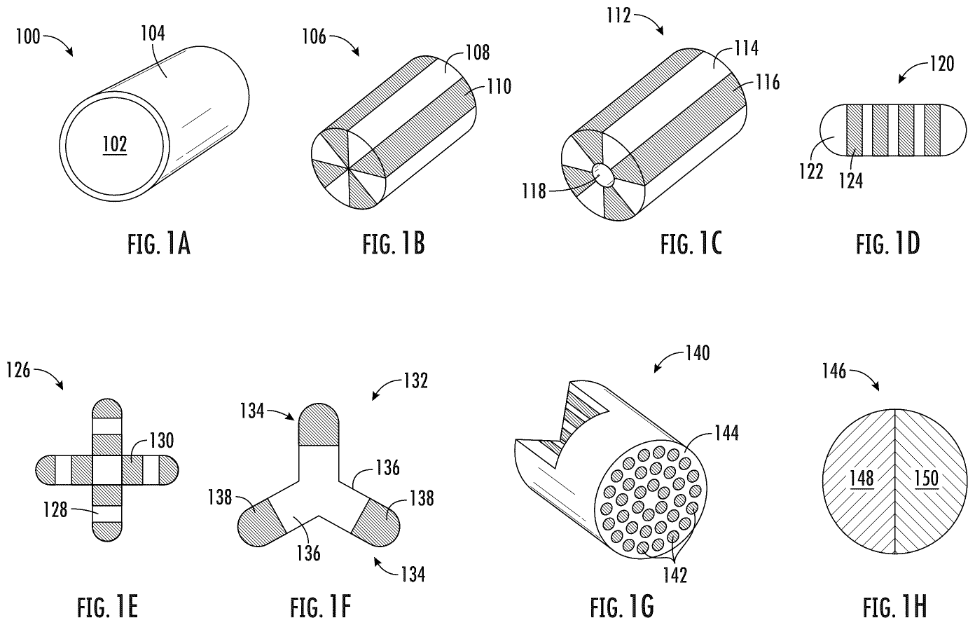

FIGS. 1A-1H illustrate schematic cross-sectional views of exemplary multicomponent fibers, according to one or more implementations discussed herein. FIG. 1A illustrates a cross-sectional view of a core shell or sheath/core fiber 100 including a core 102 and a sheath or shell 104 disposed about the core 102. The core 102 may be or include a first polymer, and the sheath 104 may be or include a second polymer. While FIG. 1A illustrates the core shell fiber 100 as having a circular cross-sectional shape, it should be appreciated that the core 102 and the shell 104 may each have a cross-sectional shape independently selected from the following: circular, rectangular, square, oval, triangular, multilobal, kidney bean, dog bone, bar bell, bowtie, star, Y-shaped, or the like.

FIG. 1B illustrates a cross-sectional view of a segmented pie fiber 106 including a plurality of pie segments 108, 110; for example, at least two, three, or more pie segments. At least two of the pie segments 108, 110 may be prepared from different polymers. For example, a first pie segment 108 may be or include a first polymer, and a second pie segment 110 may be or include a second polymer. While FIG. 1B illustrates the segmented pie fiber 106 as having a circular cross-sectional shape, it should be appreciated that the segmented pie fiber 106 may have a cross-sectional shape selected from the following: circular, rectangular, square, oval, triangular, and multilobal.

FIG. 1C illustrates a cross-sectional view of a hollow segmented pie fiber 112 including a plurality of pie segments 114, 116, each of the plurality of pie segments 114, 116 defining a bore or hole 118 extending through the hollow segmented pie fiber 112. At least two of the pie segments 114, 116 may be prepared from different polymers. For example, a first pie segment 114 may be or include a first polymer, and a second pie segment 116 may be or include a second polymer. While FIG. 1C illustrates the hollow segmented pie fiber 112 as having a circular cross-sectional shape, it should be appreciated that the hollow segmented pie fiber 112 may have a cross-sectional shape selected from the following: circular, rectangular, square, oval, triangular, and multilobal.

FIG. 1D illustrates a cross-sectional view of a segmented ribbon fiber 120 including a plurality of segments 122, 124 disposed adjacent to one another. At least two of the segments 122, 124 may be prepared from different polymers. For example, a first segment 122 may be or include a first polymer, and a second segment 124 may be or include a second polymer.

FIG. 1E illustrates a cross-sectional view of a segmented cross fiber 126 including a plurality of segments 128, 130 disposed adjacent to one another in the shape of a cross. At least two of the segments 128, 130 may be prepared from different polymers. For example, a first segment 128 may be or include a first polymer, and a second segment 130 may be or include a second polymer.

FIG. 1F illustrates a cross-sectional view of a tipped multilobal fiber 132 including three or more lobes 134, each of the lobes 134 including a body 136 and a tip 138 at a distal end of the body 136. As illustrated in FIG. 1F, the tipped multilobal fiber 132 may be a tipped trilobal fiber. The body 136 and the tip 138 may be prepared from different polymers. For example, the body 136 may be or include a first polymer, and the respective tip 138 may be or include a second polymer.

FIG. 1G illustrates a cross-sectional view of an islands in the sea fiber 140 configuration including interior fibers or islands 142 disposed in a primary fiber component or sea 144. Any one or more of the islands 142 may be prepared from different polymers than one another. Any one or more of the islands 142 may also be prepared from a different polymer than the sea 144. For example, the sea 144 may be or include a first polymer, and at least one of the islands 142 may be prepared from a second polymer. While FIG. 1G illustrates the islands in the sea fiber 140 as having a circular cross-sectional shape, it should be appreciated that the islands 142 and the sea 144 may each have a cross-sectional shape independently selected from the following: circular, rectangular, square, oval, triangular, multilobal, kidney bean, dog bone, bar bell, bowtie, star, Y-shaped, and the like.

FIG. 1H illustrates a cross-sectional view of a side-by-side or semicircular fiber 146 including a first half 148 and a second half 150 disposed adjacent to one another. The first half 148 and the second half 150 may be prepared from different polymers. For example, the first half 148 may be or include a first polymer, and the second half 150 may be or include a second polymer. While FIG. 1H illustrates the side-by-side fiber 146 as having a circular cross-sectional shape, it should be appreciated that the side-by-side fiber 146 may have a cross-sectional shape selected from the following: circular, rectangular, square, oval, triangular, multilobal, kidney bean, dog bone, bar bell, bowtie, star, Y-shaped, and the like.

It should be appreciated that any of the configurations illustrated in FIGS. 1A-1H may also be prepared as monocomponent fibers. For example, any one of the fibers discussed herein may include monocomponent ribbon fibers, monocomponent trilobal fibers, monocomponent cross fibers, or the like. It should further be appreciated that other configurations for the monocomponent and/or multicomponent fibers are contemplated. For example, the fibers may also include those fibers described and discussed in U.S. Pat. Pub. Nos. 2006/0292355, 2008/0003912, 2011/0250815, 2022/0203330, and 2023/0046170, which also discuss methods for preparing the aforementioned fibers, the contents of which are incorporated by reference herein to the extent consistent with the present application.

The fibers of the nonwoven sheet may include one or more void spaces. For example, the fibers may define one or more void spaces in the fibers thereof. The void spaces may have a circular cross-section, a rectangular cross-section, a square cross-section, an oval cross-section, a triangular cross-section, or a multilobal cross-section.

In at least one implementation, the fibers of the nonwoven sheet do not include or are substantially free of fibrillated fibers. As used herein, the term or expression “fibrillate,” “fibrillating,” or the like refers to a process of breaking apart a multicomponent fiber into a plurality of smaller fiber components. Accordingly, the fibers of the nonwoven sheet maintain the multicomponent configurations, as illustrated in FIGS. 1A-1H.

The nonwoven sheet of the filter media may include one or more layers. Any one or more of the layers of the nonwoven sheet may be the same as any one or more of the remaining layers of the nonwoven sheet. Any one or more of the layers of the nonwoven sheet may be different than any one or more of the remaining layers of the nonwoven sheet. For example, each of the layers of the nonwoven sheet may include the same fibers and/or polymers. In another example, any one of the layers of the nonwoven sheet may include fibers and/or polymers that are different than the respective fibers and/or polymers of one of the remaining layers of the nonwoven sheet.

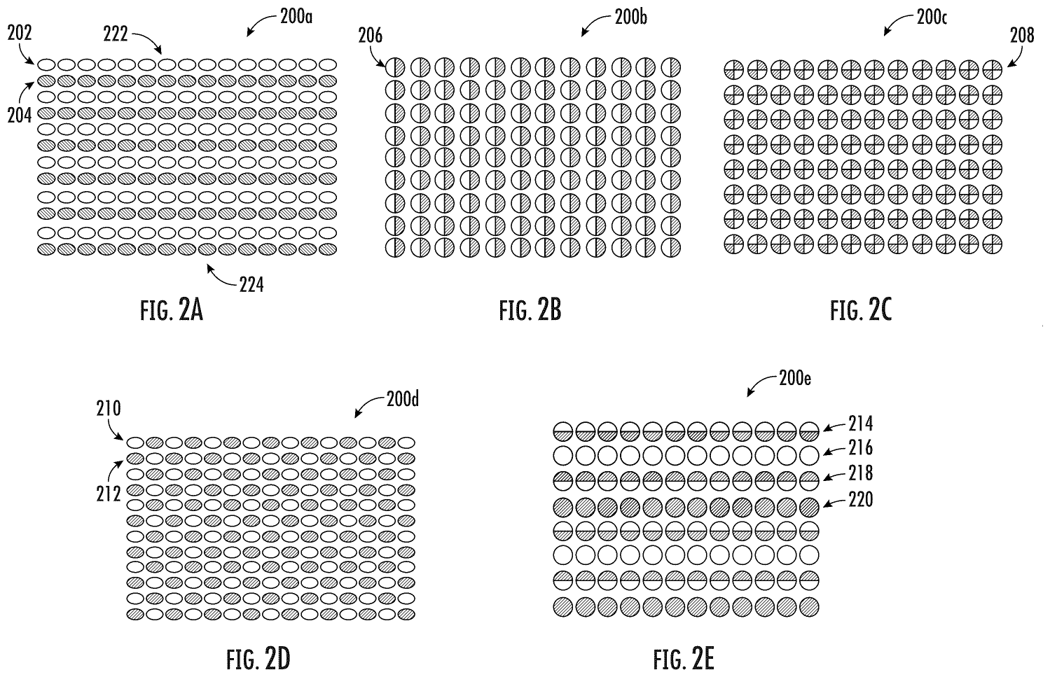

FIGS. 2A-2E illustrate schematic cross-sectional views (e.g., spin-pack design) of exemplary nonwoven sheets 200a, 200b, 200c, 200d, 200e, according to one or more implementations discussed herein. As illustrated in FIGS. 2A-2E, each of the nonwoven sheets 200a, 200b, 200c, 200d, 200e may include one or more layers 202, 204, 206, 208, 210, 212, 214, 216, 218, 220. The respective layers 202, 204, 206, 208, 210, 212, 214, 216, 218, 220 of each of the nonwoven sheets 200a, 200b, 200c, 200d, 200e may be the same or different. The respective layers 202, 204, 206, 208, 210, 212, 214, 216, 218, 220 of each of the nonwoven sheets 200a, 200b, 200c, 200d, 200e may be disposed randomly or in a pattern. For example, FIGS. 2A and 2D illustrate the nonwoven sheets 200a, 200d having a two layer 202, 204, 210, 212 pattern, FIGS. 2B and 2C illustrate the nonwoven sheets 200b, 200c having the same layers 206, 208, FIG. 2E illustrate the nonwoven sheet 200e having a four layer pattern including layers 214, 216, 218, 220. Other patterns and configurations for the respective layers of each of the nonwoven sheets are contemplated. While FIGS. 2A-2E illustrate particular types of fibers having specific cross-sections, it should be appreciated that any combination of fibers may be utilized. For example, while FIG. 2C illustrates layers 208 including segmented pie fibers, any monocomponent or multicomponent fiber may be utilized. In another example, while FIG. 2D illustrates the nonwoven sheet 200d having a two layer 210, 212 pattern, it should be appreciated that the nonwoven sheet 200d may alternatively include repeating or multiple layers 210, where each of the layers 210 is prepared from two different polymers (as shown); accordingly, the nonwoven sheet 200d may also include multiple layers of only layer 210 or only layer 212.

The respective layers 202, 204, 206, 208, 210, 212, 214, 216, 218, 220 of each of the nonwoven sheets 200a, 200b, 200c, 200d, 200e may include spunbond fibers, melt-blown fibers, or a combination thereof. For example, a first respective layer 202, 204, 206, 208, 210, 212, 214, 216, 218, 220 of each of the nonwoven sheets 200a, 200b, 200c, 200d, 200e may include a combination of spunbond fibers and melt-blown fibers. In another example, a first respective layer 202, 204, 206, 208, 210, 212, 214, 216, 218, 220 of each of the nonwoven sheets 200a, 200b, 200c, 200d, 200e may include spunbond fibers, and a second respective layer 202, 204, 206, 208, 210, 212, 214, 216, 218, 220 of each of the nonwoven sheets 200a, 200b, 200c, 200d, 200e may include melt-blown fibers. In at least one implementation, all the layers 202, 204, 206, 208, 210, 212, 214, 216, 218, 220 of the respective nonwoven sheet 200a, 200b, 200c, 200d, 200e include spunbond fibers. In another implementation, at least one of the layers 202, 204, 206, 208, 210, 212, 214, 216, 218, 220 of the respective nonwoven sheets 200a, 200b, 200c, 200d, 200e may include melt-blown fibers.

The filter media, the nonwoven sheet, the fibers thereof, and/or a portion thereof may be biodegradable or substantially biodegradable. For example, the one or more polymers of the nonwoven sheet may be or include one or more biodegradable or substantially biodegradable polymers. As used herein the term “biodegradable” may refer to a material or substance that may be decomposed by microorganisms. Illustrative biodegradable or substantially biodegradable polymers may be or include, but are not limited to, one or more of polylactic acid (PLA), poly(3-hydroxybutyrate-co-3-hydroxyhexanoate) (PHBH), polyhydroxybutyrate (PHB), polybutylene succinate (PBS), poly(butyleneadipate-co-terephthalate) (PBAT), poly(3-hydroxybutyrate-co-e-hydroxyvalerate) (PHBV), polyhydroxyalkanoate (PHA), polycaprolactone (PCL), polycaprolactone butylene succinate (PCL-BS), polybutylene succinate adipate (PBSA), polyethylene terephthalate, polyethylene terephthalate succinate (PETS), cellulose acetate (CA), one or more petroleum-based biodegradable polymers, derivatives thereof, copolymers thereof, or any combination thereof.

In addition to the foregoing biodegradable polymers, the one or more polymers utilized to prepare the fibers of the nonwoven sheet described herein may also be or include, but are not limited to, one or more of polypropylene, polyesters, polyethylene naphthalate (PEN) polyester, polycyclohexylene dimethylene terephthalate (PCT) polyester, polypropylene (PP), polybutylene terephthalate (PBT) polyester, co-polyamides, polyethylene, high density polyethylene (HDPE), linear low density polyethylene (LLDPE), cross-linked polyethylene, polycarbonates, polyacrylates, polyacrylonitriles (PAN), polyfumaronitrile, a polymer prepared from fumaronitrile, polystyrenes (PS), styrene maleic anhydride, polymethylpentene, cyclo-olefinic copolymers, fluorinated polymers, polytetrafluoroethylene, perfluorinated ethylene and hexfluoropropylene or a copolymer with PVDF, such as P (VDF-TrFE) or poly(vinylidene fluoride-co-trifluoroethylene) copolymer with 80% molar VDF content, or terpolymers, such as P (VDF-TrFE-CFE), polyolefins, polyacrylates, thermoplastic liquid crystalline polymers, propylene, polyimides (PI), Kevlar, polyether ketones, cellulose ester, cotton, ramie, chitosan, wool, cuprammonium rayon (cupro), Lyocell, nylon, polyamides, silk, polyether-polyurea copolymers, Lycra, elastane, polymethacrylic polymers, poly(methyl methacrylate), polyoxymethylene, polysulfonates, acrylic, modacrylic, styrenated acrylics, pre-oxidized acrylic, fluorinated acrylic, vinyl acetate, vinyl acrylic, ethylene vinyl acetate, styrene-butadiene, ethylene/vinyl chloride, vinyl acetate copolymer, latex, polyester copolymer, carboxylated styrene acrylic or vinyl acetate, epoxy, acrylic multipolymers, phenolic, polyurethane, cellulose, polytetrafluoroethylene (PTFE), polytrimethylene terephthalate, polyethylene, aliphatic polyesters, thermoplastic polyacrylonitrile (PAN), styrene, or any combination thereof. It should be appreciated that other polymers conventionally utilized for fibers are contemplated.

The fibers of the nonwoven sheet may have the same or different linear mass densities, as measured in denier or den (D). For example, referring to FIG. 2A, the fibers of a first layer 202 of the nonwoven sheet 200a may have the same or different linear mass density as a second layer 204 of the nonwoven sheet 200a. The fibers may have a linear mass density of from about 0.5 den (D) to about 50 D, about 1 D to about 10 D, about 1 D to about 6 D, or about 2 D to about 4 D.

The fibers of the nonwoven sheet may have a thickness or diameter of from about 0.1 μm to about 5,000 μm, about 1 μm to about 1,000 μm, or about 10 μm to about 100 μm. For example, fibers of the nonwoven sheet may have a diameter of from about 0.1 μm to about 200 μm, or from about 5 μm to about 50 μm. In another example, the fibers of the nonwoven sheet may have a diameter of from about 0.1 μm to 100 μm or less, about 10 μm to about 50 μm, about 20 μm to about 40 μm, or about 30 μm. It should be appreciated that the thickness or diameter of the fibers may be determined or measured according to reference test ASTM-D1577 of the American Society for Testing and Materials (ASTM).

The fibers of the nonwoven sheet may have a spin finish of 2% or lower, and preferably no or substantially no spin finish (e.g., naked fibers). As used herein, the term or expression “spin finish” may refer to a liquid, a solid, or an emulsion composition that may be applied to the surfaces of fibers to improve the processing of the fibers.

The fibers of the nonwoven sheet may have a tenacity or tensile strength of from about 25 cN/tex to about 100 cN/tex. For example, the fibers of the nonwoven sheet may have a tenacity of from about 25 cN/tex, about 35 cN/tex, or about 45 cN/tex to about 50 cN/tex, about 70 cN/tex, about 80 cN/tex, or about 100 cN/tex. In another example, the fibers of the nonwoven sheet may have a tenacity of from about 25 cN/tex to about 100 cN/tex, about 35 cN/tex to about 60 cN/tex, or about 45 cN/tex. As used herein, the term or expression “tenacity” may refer to the mass stress at break. It should be appreciated that the tenacity may be determined by or with a single fiber test system, such as the Automatic Single-Fibre Test System FAVIMAT+, which is commercially available from Textechno H. Stein GmbH & Co. KG of Mönchengladbach Ost, Germany. The Automatic Single-Fibre Test System FAVIMAT+ is capable of determining the linear density, tensile properties, mechanical crimp properties, geometric crimp structure, fibre-to-metal friction, bending stiffness, or a combination thereof.

The fibers of the nonwoven sheet may have an elongation of from about 10% to about 150%. For example, the fibers of the nonwoven sheet may have an elongation of from about 10%, about 20%, about 30%, or about 35% to about 40%, about 50%, about 70%, about 80%, or about 150%. In another example, the fibers of the nonwoven sheet may have an elongation of from about 10% to about 100%, about 20% to about 70%, about 30% to about 40%, or about 35%. As used herein, the term or expression “elongation” may refer to the amount of extension or stretch that a fiber or fiber accepts before it breaks. It should be appreciated that the elongation may be determined by or with a single fiber test system, such as the Automatic Single-Fibre Test System FAVIMAT+, which is commercially available from Textechno H. Stein GmbH & Co. KG of Mönchengladbach Ost, Germany.

The fibers of the nonwoven sheet may have a single fiber fineness of from about 0.55 dtex to about 55 dtex. For example, the fibers may have a single fiber fineness of from about 0.55 dtex, about 0.6 dtex, about 1 dtex, about 2 dtex, about 3 dtex, about 4 dtex, about 5 dtex, about 6 dtex, about 6.5 dtex, about 6.7 dtex, about 7 dtex, about 8 dtex, about 9 dtex, about 10 dtex, about 20 dtex, about 25 dtex, or about 30 dtex to about 35 dtex, about 40 dtex, about 45 dtex, about 50 dtex, or about 55 dtex. In another example, the fibers may have a single fiber fineness of from about 0.55 dtex to about 55 dtex, about 5 dtex to about 40 dtex, or about 15 dtex to about 25 dtex. It should be appreciated that the single fiber fineness may be adjusted to at least partially modify or adjust one or more properties of the nonwoven sheet including, but not limited to, air permeability, average pore size, or any combination thereof.

The filter media, the nonwoven sheets, and/or the fibers thereof may include one or more charge additives or charge control agents (CCA). For example, the filter media, the nonwoven sheets, and the continuous fibers thereof may include one or more charge additives or charge control agents. The one or more charge additives or charge control agents may be disposed about an outer surface of the fibers. The one or more charge additives or charge control agents may be disposed in or incorporated into the polymer of the fibers. For example, the one or more charge additives or charge control agents may be compounded with the one or more polymers utilized to prepare the fibers of the nonwoven sheet of the filter media. The one or more charge additives or charge control agents may be homogenously dispersed in the nonwoven sheet and/or the fibers thereof.

The one or more charge additives may be capable of or configured to modify (e.g., increase or decrease) a triboelectric charge of the filter media, the nonwoven sheets, and/or the fibers thereof. The one or more charge additives may also be capable of or configured to increase the stability and/or duration of the triboelectric charge of the filter media, the nonwoven sheets, and/or the fibers thereof. The one or more charge additives may be capable of or configured to modify the triboelectric charge, increase the stability, and/or increase the duration of the triboelectric charge without compromising other characteristics or properties of the filter media, including, longevity, loading capacity, and/or pressure drop.

The filter media, the nonwoven sheet, and/or the fibers thereof may include the charge control agents in an amount of from about 0.02 wt % to about 33 wt % based on the total weight of the filter media, the nonwoven sheet, and/or the fibers thereof, respectively. For example, the filter media, the nonwoven sheet, and/or the fibers thereof may include the charge control agents in an amount of from about 0.2 wt %, about 1 wt %, about 5 wt %, about 10 wt %, or about 15 wt % to about 20 wt %, about 25 wt %, about 30 wt %, or about 33 wt %, based on the total weight of the filter media, the nonwoven sheet, and/or the fibers thereof, respectively.

The charge additives may be or include, but are not limited to, one or more of triphenylmethanes, ammonium compounds, immonium compounds, fluorinated ammonium compounds, fluorinated immonium compounds, biscationic acid amides, polymeric ammonium compounds, diallylammonium compounds, arylsulfide derivatives, phenol derivatives, phosphonium compounds, fluorinated phosphonium compounds, calix (n) arenes, metal complex compounds, benzimidazolones, azines, thiazines, oxazines, light stabilizer, hindered amine light stabilizer, or the like, or any combination thereof. Illustrative charge additives may also be or include, but are not limited to, one or more nucleating agents having a surface charge that is opposite to the partial charge of the polymer, such as magnesium stearate (MgSt), phosphonium salts (e.g., triphenyl phosphine, tributyl phosphine, trimethyl phosphine, dimethyl phenyl phosphine, methyl diphenyl phosphine, tris(2-ethylhexyl)phosphine, tetrabutyl-phosphonium hexafluorophosphate, tetrabutyl-phosphonium-hydrogen sulfate, and tetrabutylammonium-phenylphosphonate), pyridinium salts (e.g., tritylpyridinium tetrafluoroborate), pyrrolidinium salts (e.g., 1-butyl-1-methylpyrrolidinium bromide), sulfonium (e.g., triphenylsulfonium tetrafluoroborate), sulfonate (e.g., sodium octyl sulfonate), phosphonate (e.g., phosphonic acids, esters, and salts; phosphinic acid, esters, and salts; phosphonamides; phosphinamides)phosphonate (e.g., tetrabutylammonium-phenylphosphonate), or the like, or any combination thereof. Illustrative charge additives may also include, but are not limited to, one or more of high dielectric constant articles, such as CaCu3Ti₄O₁₂, BaTiO₃ and TiO₂, more electronegative articles than PP such as PTFE and silicon, articles with ultra-low dielectric loss tangent property, such as silicon nitride, alumina, ceramic, high density polyethylene, or the like, or any combination thereof. Illustrative charge additives may also be or include, but are not limited to, metal salt of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, monoazo metal compound, alkyl acrylate monomers, alkyl methacrylate monomers, polytetrafluoroethylene, alkylene, arylene, arylenedialkylene, alkylenediarylene, oxydialkylene or oxydiarylene, polyacrylic and polymethacrylic acid compound, organic titanate, quaternary phosphonium trihalozincate salts, organic silicone complex compound, dicarboxylic acid compound, cyclic polyether or non-cyclic polyether and cyclodextrin, complex salt compound of the amine derivative, ditertbutylsalicylic acid, potassium tetraphenylborate, potassium bis borate, sulfonamides and metal salts, cycloalkyl, alumina particles treated with silane coupling from group consisting of dimethyl silicone compound, azo dye, phthalic ester, quaternary ammonium salt, carbazole, diammonium and triammonium, hydrophobic silica and iron oxide, phenyl, substituted phenyl, naphthyl, substituted naphthyl, thienyl, alkenyl and alkylammonium complex salt compound, sodium dioctylsulfosuccinate and sodium benzoate, zinc complex compound, mica, monoalkyl and dialkyl tin oxides and urethane compound, metal complex of salicylic acid compound, oxazolidinones, piperazines or perfluorinated alkane, lecigran MT, nigrosine, fumed silca, carbon black, para-trifluoromethyl benzoic acid and ortho-fluoro benzoic acid, poly(styrene-co-vinylpyridinium toluene sulfonate), methyl or butyltriphenyl complex aromatic amines, triphenylamine dyes and azine dyes, alkyldimethylbenzylammonium salts, or the like, or any combination thereof. In an exemplary implementation, the charge additive may include an electret additive with the tradename FWM02™, which is commercially available from Keimei Plastifizierung Technik (Yantai) Co., Ltd. of Shandong Province, China. FWM02™ increases the charge density on the surface of the fiber to thereby increase the charge holding period thereof. FWM02™ may increase the melt strength of the fiber as compared to fibers without the charge additive. Increasing the melt strength of the fibers with the charge additive FWM02™ may reduce the relative amount of defects (e.g., melt shot, broken fibers, etc.) to thereby increase the ability of the fibers to hold and/or generate charge. FWM02™ has a bulk density of from about 0.50 g/cm3 to about 0.55 g/cm3, a granular weight of from about 60 ea/g to about 65 ea/g, a filter pressure value (FPV) of less than or equal to 0.5 bar/g, a pressure rising value (PRV) of less than or equal to about 0.5 Pa/g, and/or a melt flow index of about 650-655 g/10 min. In another implementation, the charge additive may include an electret additive with the tradename CON-CHARGE 01585, which is commercially available from CONSTAB Polyolefin Additives GmbH of Ruthen, Germany. Illustrative charge control agents may be or include, but are not limited to, one or more metal salts of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, a monoazo metal compound, alkyl acrylate monomers, alkyl methacrylate monomers, polytetrafluoroethylene, alkylene, alkylene-based CCAs, arylene, arylene-based CCAs, arylenedialkylene, alkylenediarylene, silicon nitride, PTFE, tourmaline, acid anhydride, maleic anhydride, alkylene glycol, polyethylene glycol, PDLA, CTL-01 and CN-L01 by Polyvel, Talc (Jetfine by Imerys or SK-9900 by Liaoniing Jinghua New Materials), N′1,N′6-dibenzoyladipohydrazide (TMC-306 by Shanxi Chemical research), aromatic sulfonate derivatives (LAK 301 by Takemoto Oil and Fat Co. Ltd.), sorbitol (SORB by Euro OTC Pharma Gmbh), polyethylene glycol, NA S516 by Sukano, NC PL830 by KRITILEN, MAXITHEN® BIOL by Gabriel-Chemie, dioctyl adipate, ethylene bisstearamide, zinc phenyl phosphonate (PPZn), ECOPROMOTE® by Nissan chemical, or the like, or any combination thereof. The one or more charge additives may also be or include, but are not limited to, an electret additive having the tradename MagIQ™, which is commercially available from Avient of Avon Lake, OH, USA. Additional CCAs that may be utilized may be found in U.S. Pat. No. 10,571,137, the contents of which are incorporated herein to the extent consistent with the present application. The charge additive may include any combination of the foregoing.

The fibers of the nonwoven sheets may include one or more waxes. Illustrative waxes may be or include, but are not limited to, one or more of polyolefin, polyethylene, functionalized wax, such as amines, amides, fluorinated waxes, mixed fluorinated and amide waxes, such as esters, quaternary amines, carboxylic acids or acrylic polymer emulsion, chlorinated polyethylenes, natural or synthetic ester waxes, carnauba wax, paraffin, or the like, or any combination thereof. The one or more waxes may be fractionated or distilled to provide specific cuts that meet certain viscosity and/or temperature criteria.

The fibers of the nonwoven sheets may include one or more additives. Illustrative additives may be or include, but are not limited to, one or more antibacterial agents or compositions, one or more antiviral agents or compositions, or a combination thereof. Illustrative antibacterial and antiviral agents or compositions may be or include, but are not limited to, silver (e.g., silver nanoparticles, etc.), zinc, copper, organosilicon, tributyl tin, compounds thereof, complexes thereof, one or more organic compounds, such as organic compounds including one or more of chlorine, bromine, fluorine, or any combination thereof.

In at least one implementation, one or more properties of the nonwoven sheet or the fibers thereof may be modified (e.g., increased or decreased) from one side or surface to an opposing side or surface thereof. The modification may be a gradual gradient or stepwise. For example, referring to FIG. 2A, the fibers of the nonwoven sheet 200a disposed proximal a first side 222 of the nonwoven sheet 200a may have one or more properties relatively greater than or less than the fibers of the nonwoven sheet 200a disposed proximal a second or opposing side 224 of the nonwoven sheet 200a. Illustrative properties that may be modified may be or include, but are not limited to, pore size, density of fibers, diameter of fibers, thickness of layers, charge density of the fibers or layers, relative concentration or amount of the polymers used to prepare the fibers, or the like, or any combination thereof. It should be appreciated that the density of fibers may refer to the mass density of the fibers and/or the total amount of fibers, and may be determined through conventional techniques, such as scanning electron microscopy (SEM). In at least one example, referring to FIG. 2A, the fibers of the nonwoven sheet 200a disposed proximal the first side 222 of the nonwoven sheet 200a may have one or more of a pore size, a density of fibers, a concentration of a first polymer, or a combination thereof relatively greater than or less than the fibers of the nonwoven sheet 200a disposed proximal the second or opposing side 224 of the nonwoven sheet 200a. The modification of the fibers from one side or surface to an opposing side or surface may allow one or more properties of the nonwoven sheet to be at least partially tuned or adjusted, either directly or indirectly. For example, the modification of the fibers from one side or surface to an opposing side or surface may increase the efficacy of the nonwoven sheet to generate and/or maintain a triboelectric charge. For example, the concentration of the first or second polymer in the fibers on the first side of the nonwoven sheet may be increased or decreased toward an opposing side to thereby increase the efficacy of the nonwoven sheet to generate and/or maintain a triboelectric charge.

In at least one implementation, the nonwoven sheet includes fibers prepared from a first polymer and a second polymer, where the first polymer is polypropylene and the second polymer is selected from nylon, polylactic acid (PLA), and a melt processable polyacrylonitrile. The fibers may include monocomponent fibers prepared from polypropylene and monocomponent fibers prepared from the second polymer. The fibers may also include multicomponent or bicomponent fibers prepared from polypropylene and the second polymer. The nonwoven sheet may include a single layer or a plurality of layers. The fibers may have a diameter of from about 5 μm to about 40 μm, about 10 μm to about 30 μm, or about 20 μm. The first polymer and/or the second polymer may include one or more nucleating agents and/or charge control agents in an amount less than or equal to about 20 wt %, based on the total weight of the nonwoven sheet or the fibers thereof. The nonwoven sheet may have a weight of from about 10 gsm to about 110 gsm, about 80 gsm to about 100 gsm, or about 90 gsm. The nonwoven sheet may have a thickness of from about 0.5 mm to about 50 mm, about 0.7 mm to about 10 mm, about 0.9 mm to about 4 mm, or about 1 mm to about 3 mm. The nonwoven sheet may be needled. The nonwoven sheet may also be subjected to ultrasonic bonding after needling. It should be appreciated that the thickness of the nonwoven sheet may be determined or measured according to reference test ASTM-D5736 of the American Society for Testing and Materials (ASTM).

In an exemplary implementation, one or more polymers or resins utilized to prepare a first polymer may be or include a polypropylene having a melt flow index of from about 15 MFI to about 40 MFI. Illustrative polymers or resins may be or include, but are not limited to, one or more of ExxonMobil™ PP 1074KNE1, ExxonMobil™ PP 3155E5, Total Polypropylene 3865, or any combination thereof. ExxonMobil™ PP 1074KNE1 is a nucleated, medium melt flow rate homopolymer resin with mold release and anti-static properties. ExxonMobil™ PP 3155E5 is a homopolymer resin produced with a catalyst system that does not include intentionally added phthalate compounds. Total Polypropylene 3865 is a homopolymer that excludes phthalates. One or more polymers or resins utilized to prepare a second polymer may be or include a polylactic acid (PLA) having a melt flow index of from about 10 MFI to about 100 MFI. Illustrative polymers or resins may be or include, but are not limited to, INGEO™ Biopolymer 6202D, INGEO™ Biopolymer 6252D, INGEO™ Biopolymer 6100D, LUMINY® PLA L175, LUMINY® PLA L130, LUMINY® PLA LX530, LUMINY® PLA LX175, LUMINY® PLA LX975, or any combination thereof. The first polymer and the second polymer may be utilized to prepare a nonwoven sheet according to any one or more of the configurations illustrated in FIGS. 2A-2E. For example, the first and second polymers may be utilized to prepare the nonwoven sheet 200d, according to FIG. 2D. The nonwoven sheet 200d may be prepared via bicomponent spunbonding. The fibers prepared from the first and/or second polymers may have a filament size of from about 2 denier per filament (DPF) to about 4 DPF or about 3 DPF, a weight or web weight of from about 85 gsm to about 95 gsm or about 90 gsm, or a combination thereof. The nonwoven sheet 200d prepared from a fibrous web of the first and second polymers via needling in a needleloom. The needleloom may have a needle board density of from about 3000 needles/m to about 7000 needles/m, about 4000 needles/m to about 6000 needles/m, or about 5000 needles/m. The operating conditions of the needleloom may be according to the following: density of about 50 (punch/cm²) or (stitch/cm²), and penetration depth of about 8.5 mm. The needled nonwoven sheet 200d may be point bonded via calendaring.

Methods for preparing the filter media, the nonwoven sheets, and the fibers thereof are described. The method may include preparing continuous fibers from a first polymer and a second polymer, wherein the first polymer is different than the second polymer. The method may include mixing or otherwise combining the fibers with one another. The method may also include needling the continuous fibers with one another to prepare a nonwoven sheet of the continuous fibers. The continuous fibers may be triboelectrically charged via needling. In one implementation, the continuous fibers include spunbond fibers, melt-blown fibers, or a combination thereof.

The method may further include bonding or otherwise coupling the fibers of the nonwoven sheet with one another to prepare the nonwoven sheet. Bonding the fibers of the nonwoven sheet with one another may be or include a non-thermal process, such as needling or needle-punching, ultrasonic bonding, air-through bonding, hydroentangling, or a combination thereof. Bonding the fibers of the nonwoven sheet with one another may also include a thermal process, such as point bonding via calendaring. In an exemplary implementation, the method for preparing the filter media does not include a thermal process wherein the fibers are heated. The method also does not include carding, crimping, or any combination thereof.

In an exemplary embodiment, the polymer resin for the first and second polymers is fed through an extruder and melted into liquid form by applying heat and pressure within the extruder. The melted polymer is then forced through tiny spinnerets, or nozzle-like devices that have small holes, which determine the diameter of the fibers (discussed above). The polymer melt emerges as thin filaments or fibers from the spinneret and are then cooled using cold air or water to solidify the fibers. The continuous filaments are then deposited onto a conveyor belt or a moving surface and calendared to form a solid non-woven sheet or layer. In some embodiments, the fibers may be bonded to each other via ultrasonic bonding or another non-thermal bonding method, as described above.

After bonding, the nonwoven fabric is calendered to form a smooth and more compact fabric. In one embodiment, the nonwoven sheet is then hydroentangled via water jets to further bond the fibers, triboelectrically charge the first and second polymers to each other and improve texture. In another embodiment, the nonwoven sheet is fed into a needleloom, which contains a series of barbed needles. The needles repeatedly punch into the fiber web, driving the fibers down onto the mat and interlocking them together. The needles also triboelectrically charge the first and second polymers to each other. Finally, the nonwoven sheet is wound onto large rolls, ready for processing or cutting into sheets or finished products, such as filters.

### Example 1

Applicant prepared 4 separate samples of nonwoven sheets for use with filter media: (1) a nonwoven sheet comprising spunbond discontinuous or staple fibers without needling or hydroentanglement (the “Control”); (2) a nonwoven sheet of continuous spunbond fibers comprising a first polymer consisting of 96% polypropylene (PP) resin have a melt flow index (MFI) of 35 and 4% PP, and a second polymer consisting of 100% PLA and needled (e.g., needlepunched) in the lab (“Sample 1”); (3) a nonwoven sheet of continuous spunbond fibers comprising a first polymer consisting of 96% polypropylene (PP) resin have a melt flow index (MFI) of 35 and 4% PP, and a second polymer consisting of 100% PLA and manufacture needled once (“Sample 2”); and (4) a nonwoven sheet of continuous spunbond fibers comprising a first polymer consisting of 96% polypropylene (PP) resin have a melt flow index (MFI) of 35 and 4% PP, and a second polymer consisting of 100% PLA and manufacture needled twice (“Sample 3”).

Applicant tested the four samples for air permeability in cubic feet/minute (cfm) (“Air Perm”) according to ASTM D6830, particle penetration as a percentage of the number of particles passing through the filter divided by the total number of particles introduced (“PEN”) according to ASTM F2299, and resistivity in inches of water (“RES”) at both 32 liters/minute (32 lpm) and 85 lpm according to ASTM D6830. Applicant also measured the thickness of the nonwoven sheets according to ASTM D374, the basis weight (“BW”) of the nonwoven sheets according to ASTM D646 and the fiber diameter according to ASTM D689. The results of this testing are shown below in Table 1.

TABLE 1

| | | | | | PEN | RES | PEN | RES |
|---|---|---|---|---|---|---|---|---|
| | Total | Fiber | Thick- | Air | (32 | (32 | (85 | (32 |
| Sample | BW | BW | ness | Perm | lpm) | lpm) | lpm) | lpm) |
| Control | 101.144 | 101.144 | 32 | 282.7 | 61.9 | 0.6 | 94.7 | 1.1 |
| Sam- | 117.9 | 104.4 | 105 | 258.8 | 32.8 | 0.4 | 73.2 | 0.9 |
| ple 1 | | | | | | | | |
| Sam- | 117.9 | 104.4 | 105 | 258.8 | 28.4 | 0.3 | 42.4 | 1.0 |
| ple 2 | | | | | | | | |
| Sam- | 117.9 | 104.4 | 105 | 258.8 | 26.6 | 0.6 | 44.8 | 1.0 |
| ple 3 | | | | | | | | |

As shown in Table 1, the thickness of the nonwoven sheets increased substantially when the sheets were needled (Samples 1-3 compared to the Control), while the basis weight remained substantially the same. Increasing the thickness at the same basis weight increases the loftiness of the filter media, which reduces the resistance to airflow and increases the dust holding capacity of the filter media. Loftiness refers to the thickness, fluffiness, or bulkiness of the material. It describes how much the fibers are loosely packed or how much air is trapped within the structure, contributing to its softness and volume. This was demonstrated in the results in Table 1. The particle penetration (or percentage of the number of particles passing through the filter) reduced substantially with the needled samples (i.e., from 61.9% to between 26.6% to 32.8% at 32 lpm and from 94.7% to as low as 42.4% to 44.8%). In addition, the resistivity of the filter media remained substantially the same.

### Example 2

Applicant prepared 8 separate samples of nonwoven sheets for use with filter media (1) four nonwoven sheets comprising continuous spunbond fibers without needling or hydroentanglement (the “Controls 1-4”); and (2) four nonwoven sheets of continuous spunbond fibers comprising a first polymer consisting of 96% polypropylene (PP) resin have a melt flow index (MFI) of 35 and 4% PP, and a second polymer consisting of 100% PLA and hydroentangled (“Samples 1-4”. Applicant tested both the resistance (in mm/w.g.) and the particle penetration percentage of each of the controls and samples at a flow rate of 32 lpm. The result of this testing is shown below in Tables 2 and 3.

TABLE 2

| | Con- | Con- | Con- | Con- | | | |
|---|---|---|---|---|---|---|---|
| | trol 1 | trol 2 | trol 3 | trol 4 | AVG | Min | Max |
| Penetration % | 83.0 | 79.0 | 78.4 | 81.0 | 80.4 | 78.4 | 83.0 |
| Resistance | 0.11 | 0.05 | 0.11 | 0.06 | 0.083 | 0.05 | 0.11 |

TABLE 3

| | Sam- | Sam- | Sam- | Sam- | | | |
|---|---|---|---|---|---|---|---|
| | ple 1 | ple 2 | ple 3 | ple 4 | AVG | Min | Max |
| Penetration % | 67.6 | 65.2 | 65.6 | 67.6 | 66.48 | 65.16 | 67.6 |
| Resistance | −0.01 | 0.03 | 0.01 | 0.01 | 0.01 | −0.01 | 0.03 |

As shown in Tables 2 and 3, hydroentangling the fibers in the nonwoven sheet increased the loftiness of the media and tribocharged the media. Thus, the particle penetration percentages were substantially decreased (i.e., from an average of 80.4% to 66.48%) and the resistance was also decreased (i.e., from an average of 0.083 mm/w.g to 0.05 mm/w.g). Thus, hydroentangling the continuous spunbond fibers in the nonwoven sheet significantly improves the performance of the filter media.

It should be appreciated that the methods described, including modifications thereof, omit or remove conventional steps or processes for preparing or fabricating the filter media and the nonwoven sheets thereof. For example, the filter media and the nonwoven sheets thereof are prepared without one or more of cutting the fibers, crimping the fibers, carding the fibers, thermally treating the fibers to bond the fibers with one another, or any combination thereof. Accordingly, the method for preparing the filter media and the nonwoven sheets thereof may only include needling continuous spunbond fibers prepared from a first polymer and a second polymer with one another. It should be appreciated that needling the continuous fibers of the first polymer and the second polymer (e.g., as monocomponent fibers, multicomponent fibers, or a combination) may at least partially couple the fibers with one another and concurrently triboelectrically charge the fibers. The methods described are relatively cost effective and exhibits reduced processing times as compared to conventional methods for preparing electret filter media and fibrous sheets thereof.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

For example, in accordance with one aspect, a first embodiment is a filter media comprising continuous fibers comprising a first polymer and a second polymer, wherein the first polymer is different than the second polymer and at least a portion of the continuous fibers are triboelectrically charged.

A second embodiment is the first embodiment, wherein the continuous fibers comprise spunbond fibers, melt-blown fibers, or a combination thereof.

A third embodiment is any combination of the above embodiments, wherein the filter media comprises a nonwoven sheet of the continuous fibers needled with each other.

A 4^{th} embodiment is any combination of the above embodiments, wherein the filter media comprises a nonwoven sheet of the continuous fibers hydroentangled with each other.

A 5^{th} embodiment is any combination of the above embodiments, wherein the filter media comprises a nonwoven sheet of the continuous fibers having a thickness of about 50 mils to about 150 mils.

A 6^{th} embodiment is any combination of the above embodiments, wherein the thickness is about 80 mils to about 120 mils.

A 7^{th} embodiment is any combination of the above embodiments, wherein the thickness is about 100 mils to about 110 mils.

An 8^{th} embodiment is any combination of the above embodiments, wherein the nonwoven sheet has a basis weight of about 80 to about 140 gsm.

A 9^{th} embodiment is any combination of the above embodiments, wherein the basis weight is about 110 gsm to about 125 gsm.

A 10^{th} embodiment is any combination of the above embodiments, wherein the continuous fibers have an average diameter of about 1 micron to about 100 microns.

An 11^{th} embodiment is any combination of the above embodiments, wherein the average diameter is about 1 micron to about 30 microns.

A 12^{th} embodiment is any combination of the above embodiments, wherein the average diameter is about 1 micron to about 10 microns.

A 13^{th} embodiment is any combination of the above embodiments, wherein the continuous fibers comprise: monocomponent fibers prepared from the first polymer; and monocomponent fibers prepared from the second polymer.

A 14^{th} embodiment is any combination of the above embodiments, wherein the filter media comprises a nonwoven sheet comprising: a first layer comprising monocomponent fibers prepared from the first polymer; and a second layer comprising monocomponent fibers prepared from the second polymer.

A 15^{th} embodiment is any combination of the above embodiments, wherein the first layer comprises a combination of the monocomponent fibers prepared from the first polymer and monocomponent fibers prepared from the second polymer.

A 16^{th} embodiment is any combination of the above embodiments, wherein the continuous fibers comprise multicomponent fibers prepared from the first polymer and the second polymer.

A 17^{th} embodiment is any combination of the above embodiments, wherein the multicomponent fibers comprise one or more of the following configurations: side by side, core-shell, islands in the sea, solid segmented pie, hollow segmented pie, ribbon, segmented ribbon, tipped multilobal, segmented cross, or a combination thereof.

An 18^{th} embodiment is any combination of the above embodiments, wherein the continuous fibers are ultrasonically bonded to one another.

A 19^{th} embodiment is any combination of the above embodiments, wherein the continuous fibers are point calendar bonded to one another.

A 20^{th} embodiment is any combination of the above embodiments, wherein the continuous fibers comprise spunbond continuous fibers and melt-blown continuous fibers.

A 21^{st} embodiment is any combination of the above embodiments, wherein the continuous fibers consist of spunbond continuous fibers.

A 22^{nd} embodiment is any combination of the above embodiments, wherein the first polymer is polypropylene.

A 23^{rd} embodiment is any combination of the above embodiments, wherein the first polymer is a PP resin having a melt flow index (MFI) of about 20 to about 35.

A 24^{th} embodiment is any combination of the above embodiments, wherein the PP resin has an MFI of about 20 to about 25

A 25^{th} embodiment is any combination of the above embodiments, wherein the second polymer is a thermoplastic polymer.

A 26^{th} embodiment is any combination of the above embodiments, wherein the thermoplastic polymer is selected from the group consisting of polyacrylic acid (PAA), ester derivatives of polyacrylic acid, poly(methyl methacrylate) (PMMA), acrylonitrile butadiene styrene (ABS), nylon, polylactic acid (PLA), polyether ether ketone (PEEK), polyetherimide (PEI), polyethylene (PE), polypropylene, polystyrene (PS), polyvinyl chloride (PVC), copolymers thereof, derivatives thereof, and combinations thereof.

A 27^{th} embodiment is any combination of the above embodiments, wherein the thermoplastic polymer is PLA.

A 28^{th} embodiment is any combination of the above embodiments, further comprising an ultraviolet stabilizer.

A 29^{th} embodiment is any combination of the above embodiments, further comprising a nucleating agent.

A 30^{th} embodiment is a filter comprising any combination of the above embodiments.

In accordance with another aspect, a first embodiment is a filter media comprising: a nonwoven sheet of needled continuous fibers; and wherein at least a portion of the continuous fibers are triboelectrically charged.

A second embodiment is the first embodiment, wherein the nonwoven sheet comprises first and second dissimilar polymers.

A third embodiment is any combination of the above embodiments, wherein the filter media has a particle penetration of less than about 50% at 32 liters/minute (lpm).

A 4^{th} embodiment is any combination of the above embodiments, wherein the particle penetration is less than about 35% at 32 liters/minute (lpm).

A 5^{th} embodiment is any combination of the above embodiments, wherein the filter media has a resistivity of less than about 0.6 at 32 liters/minute (lpm).

A 6^{th} embodiment is any combination of the above embodiments, wherein the continuous fibers comprise spunbond fibers, melt-blown fibers, or a combination thereof.

A 7^{th} embodiment is any combination of the above embodiments, wherein the nonwoven sheet has a thickness of about 50 mils to about 150 mils.

An 8^{th} embodiment is any combination of the above embodiments, wherein the thickness is about 80 mils to about 120 mils.

A 9^{th} embodiment is any combination of the above embodiments, wherein the thickness is about 100 mils to about 110 mils.

A 10^{th} embodiment is any combination of the above embodiments, wherein the nonwoven sheet has a basis weight of about 80 to about 140 gsm.

An 11^{th} embodiment is any combination of the above embodiments, wherein the basis weight is about 110 gsm to about 125 gsm.

A 12^{th} embodiment is any combination of the above embodiments, wherein the continuous fibers have an average diameter of about 1 micron to about 100 microns.

A 13^{th} embodiment is any combination of the above embodiments, wherein the average diameter is about 1 micron to about 30 microns.

A 14^{th} embodiment is any combination of the above embodiments, wherein the average diameter is about 1 micron to about 10 microns.

A 15^{th} embodiment is any combination of the above embodiments, wherein the continuous fibers comprise spunbond continuous fibers and melt-blown continuous fibers.

A 16^{th} embodiment is any combination of the above embodiments, wherein the continuous fibers consist of spunbond continuous fibers.

A 17^{th} embodiment is any combination of the above embodiments, wherein the first polymer is polypropylene.

A 18^{th} embodiment is any combination of the above embodiments, wherein the second polymer is a thermoplastic polymer.

A 19^{th} embodiment is any combination of the above embodiments, wherein the thermoplastic polymer is selected from the group consisting of polyacrylic acid (PAA), ester derivatives of polyacrylic acid, poly(methyl methacrylate) (PMMA), acrylonitrile butadiene styrene (ABS), nylon, polylactic acid (PLA), polyether ether ketone (PEEK), polyetherimide (PEI), polyethylene (PE), polypropylene, polystyrene (PS), polyvinyl chloride (PVC), copolymers thereof, derivatives thereof, and combinations thereof.

A 20^{th} embodiment is any combination of the above embodiments, wherein the thermoplastic polymer is PLA.

In accordance with still another aspect, a first embodiment is a method for preparing a filter media, the method comprising: producing continuous fibers from a first polymer and a second polymer, wherein the first polymer is different than the second polymer, and needling or hydroentangling the continuous fibers to triboelectrically charge the continuous fibers.

A second embodiment is the first embodiment, wherein the continuous fibers comprise spunbond continuous fibers, melt-blown continuous fibers, or a combination thereof.

A third embodiment is any combination of the above embodiments, further comprising bonding the continuous fibers with one another to prepare a nonwoven sheet.

A 4^{th} embodiment is any combination of the above embodiments, wherein bonding the continuous fibers with one another does not include crimping, carding, or any combination thereof.

A 5^{th} embodiment is any combination of the above embodiments, wherein bonding the continuous fibers with one another comprises ultrasonic bonding.

A 6^{th} embodiment is any combination of the above embodiments, wherein bonding the continuous fibers with one another comprises point calendar bonding.

A 7^{th} embodiment is any combination of the above embodiments, further comprising: spunbonding or melt blowing a first layer of the nonwoven sheet, the first layer comprising monocomponent fibers prepared from the first polymer; and spunbonding or melt blowing a second layer of the nonwoven sheet, the second layer comprising monocomponent fibers prepared from the second polymer.

An 8^{th} embodiment is any combination of the above embodiments, further comprising spunbonding or melt blowing a first layer of the nonwoven sheet, the first layer comprising the monocomponent fibers prepared from the first polymer and the monocomponent fibers prepared from the second polymer.

A 9^{th} embodiment is any combination of the above embodiments, wherein the continuous fibers comprise multicomponent fibers prepared from the first polymer and the second polymer.

A 10^{th} embodiment is any combination of the above embodiments, wherein the multicomponent fibers comprise one or more of the following configurations: side-by-side, core-shell, islands in the sea, solid segmented pie, hollow segmented pie, ribbon, segmented ribbon, tipped multilobal, segmented cross, or a combination thereof.

An 11^{th} embodiment is any combination of the above embodiments, wherein the first polymer is polypropylene.

A 12^{th} embodiment is any combination of the above embodiments, wherein the second polymer is a thermoplastic polymer.

A 13^{th} embodiment is any combination of the above embodiments, wherein the thermoplastic polymer is selected from the group consisting of polyacrylic acid (PAA), ester derivatives of polyacrylic acid, poly(methyl methacrylate) (PMMA), acrylonitrile butadiene styrene (ABS), nylon, polylactic acid (PLA), polyether ether ketone (PEEK), polyetherimide (PEI), polyethylene (PE), polypropylene, polystyrene (PS), polyvinyl chloride (PVC), copolymers thereof, derivatives thereof, and combinations thereof.

A 14^{th} embodiment is any combination of the above embodiments, wherein the thermoplastic polymer comprises PLA.

What is claimed is:

1. A filter media comprising:
continuous fibers comprising a first polymer and a second polymer, wherein the first polymer is different than the second polymer; and
wherein at least a portion of the continuous fibers are triboelectrically charged.

2. The filter media of claim 1, wherein the filter media comprises a nonwoven sheet of the continuous fibers needled with each other.

3. The filter media of claim 1, wherein the filter media comprises a nonwoven sheet of the continuous fibers hydroentangled with each other.

4. The filter media of claim 1, wherein the filter media comprises a nonwoven sheet of the continuous fibers having a thickness of about 80 mils to about 120 mils.

5. The filter media of claim 4, wherein the nonwoven sheet has a basis weight of about 110 to about 125 gsm.

6. The filter media of claim 1, wherein the continuous fibers have an average diameter of about 1 micron to about 30 microns.

7. The filter media of claim 1, wherein the continuous fibers are ultrasonically bonded or calender bonded to one another.

8. The filter media of claim 1, wherein the continuous fibers comprise spunbond continuous fibers and melt-blown continuous fibers.

9. The filter media of claim 1, wherein the continuous fibers consist of spunbond continuous fibers.

10. The filter media of claim 1, wherein the first polymer is polypropylene.

11. The filter media of claim 10, wherein the second polymer is PLA.

12. A filter media comprising:
a nonwoven sheet of needled continuous fibers; and
wherein at least a portion of the continuous fibers are triboelectrically charged.

13. The filter media of claim 12, wherein the nonwoven sheet comprises first and second dissimilar polymers.

14. The filter media of claim 12, wherein the filter media has a particle penetration of less than about 50% at 32 liters/minute (lpm).

15. The filter media of claim 12, wherein the filter media has a resistivity of less than about 0.6 at 32 liters/minute (lpm).

16. The filter media of claim 12, wherein the continuous fibers consist of spunbond continuous fibers.

17. A method for preparing a filter media, the method comprising:
producing continuous fibers from a first polymer and a second polymer, wherein the first polymer is different than the second polymer; and
needling or hydroentangling the continuous fibers to triboelectrically charge the continuous fibers.

18. The method of claim 17, further comprising:
spunbonding or melt blowing a first layer of the nonwoven sheet, the first layer comprising monocomponent fibers prepared from the first polymer; and
spunbonding or melt blowing a second layer of the nonwoven sheet, the second layer comprising monocomponent fibers prepared from the second polymer.

19. The method of claim 17, further comprising spunbonding or melt blowing a first layer of the nonwoven sheet, the first layer comprising the monocomponent fibers prepared from the first polymer and the monocomponent fibers prepared from the second polymer.

20. The method of claim 17, wherein the continuous fibers comprise multicomponent fibers prepared from the first polymer and the second polymer.
